(19) United States
(12) Patent Application Publication
(10) Pub. No.: US 2018/0206104 A1
(43) Pub. Date: Jul. 19, 2018

(54) COMMUNICATION APPARATUS, CONTROL METHOD THEREFOR, AND PROGRAM

(71) Applicant: CANON KABUSHIKI KAISHA, Tokyo (JP)

(72) Inventor: Ichiro Tamura, Kawasaki-shi (JP)

(21) Appl. No.: 15/744,492

(22) PCT Filed: Aug. 18, 2016
(86) PCT No.: PCT/JP2016/003783

§ 371 Date: Jan. 12, 2018

(30) Foreign Application Priority Data
Sep. 24, 2015 (JP) 2015-187448

(51) Int. Cl. H04W 8/00; H04W 56/00

(52) U.S. Cl. CPC H04W 8/005; H04W 84/12; H04W 56/0015

(57) ABSTRACT

A communication apparatus receives, during each of cyclically set predetermined periods, a first signal for synchronizing with the predetermined period, determines a service which can be provided by the communication apparatus, decides, based on the determined service, a period for transmitting a second signal related to the service among the cyclically set predetermined periods, and transmits the second signal during the decided period.

### TECHNICAL FIELD

The present invention relates to a communication apparatus, a control method therefor, and a program.

### BACKGROUND ART

Wi-Fi Alliance has defined NAN (Neighbor Awareness Networking) as a standard for discovering a service executable by another apparatus (U.S. Patent Application Publication No. 2014/302787). According to U.S. Patent Application Publication No. 2014/302787, in NAN, one or more communication apparatuses form a network called a NAN cluster, and join it. These communication apparatuses communicate service information during a determined period. This enables each communication apparatus in the NAN cluster to discover a service executable by another communication apparatus in the NAN cluster.

However, when the number of communication apparatuses joining the NAN cluster increases, if all the communication apparatuses in the NAN cluster attempt to communicate service information during a determined period, the communication traffic amount abruptly increases during the predetermined period. Therefore, these communication apparatuses may not be able to successfully communicate service information due to congestion in a communication environment.

### SUMMARY OF INVENTION

In one aspect, a communication apparatus comprises: reception means for receiving, during each of cyclically set predetermined periods, a first signal for synchronizing with the predetermined period; first determination means for determining a service which can be provided by the communication apparatus; decision means for deciding, based on the service determined by the first determination means, a period for transmitting a second signal related to the service among the cyclically set predetermined periods; and transmission means for transmitting the second signal during the period decided by the decision means.

In another aspect, a control method for a communication apparatus, comprises: receiving, during each of cyclically set predetermined periods, a first signal for synchronizing with the predetermined period; determining a service provided by the communication apparatus; deciding, based on the determined service, a period for transmitting a second signal associated with the service among the cyclically set predetermined periods; and transmitting the second signal during the decided period.

Further features of the present invention will become apparent from the following description of exemplary embodiments (with reference to the attached drawings).

### BRIEF DESCRIPTION OF DRAWINGS

FIG. 1 is a view showing the configuration of a communication system.

FIG. 2 is a block diagram showing the functional arrangement of a communication apparatus.

FIG. 3 is a block diagram showing the hardware arrangement of the communication apparatus.

FIG. 4 is a flowchart illustrating the operation of the communication apparatus according to the first embodiment.

FIG. 5 is a table showing a DW table according to the first embodiment.

FIG. 6 is a sequence chart showing the sequence of the communication system according to the first embodiment.

FIG. 7 is a flowchart illustrating the operation of a communication apparatus according to the second embodiment.

FIG. 8 is a sequence chart showing the sequence of a communication system according to the second embodiment.

### DESCRIPTION OF EMBODIMENTS

The present invention will be described in detail below based on embodiments of the present invention with reference to the accompanying drawings. Note that arrangements to be described in the following embodiments are merely examples, and the present invention is not limited to the illustrated arrangements.

### First Embodiment

As the first embodiment, a case in which a transmission DW corresponding to service information has been decided will be described. Services include, for example, a data sharing service and a print service. Note that an example in which a wireless LAN system complying with the NAN (Neighbor Awareness Networking) standard is used will be explained below. In a NAN network, respective communication apparatuses communicate service information during cyclic periods called discovery windows (to be referred to as DWs hereinafter). The DWs are a predetermined period (a convergence time) set for all communication apparatuses belonging to the NAN network to perform communication. A set of communication apparatuses which share the schedule of the DWs is called a NAN cluster. In the NAN standard, the respective DWs are assigned with numerals of 0 to 15 in time series. That is, it is defined to continue from DW0 to SW15, and return to DW0 again.

Each communication apparatus belonging to the NAN cluster can operate in one of master, non-master sync, and non-master non-sync roles.

The communication apparatus operating in the master role transmits a synchronization beacon (to be referred to as a sync beacon hereinafter) as a beacon for causing each communication apparatus in the NAN cluster to identify the DW and synchronize with it. In addition, the communication apparatus operating in the master role transmits a discovery beacon as a signal for causing a terminal, which does not belong to the NAN cluster, to recognize the NAN cluster. The discovery beacon is transmitted asynchronously with the DW for, for example, every 100 ms. Note that in each NAN cluster, at least one communication apparatus operates in the master role.

The communication apparatus operating in the non-master sync role transmits not a discovery beacon but a sync beacon. Furthermore, the communication apparatus operating in the non-master non-sync role transmits neither a sync beacon nor a discovery beacon.

In accordance with the received sync beacon, the communication apparatus joining the NAN cluster communicates service information during the DW period in synchronous with the DW period set in every predetermined cycle. More specifically, the communication apparatuses communicate, with each other, a subscribe message as a signal for discovering a service during the DW period and a publish message as a signal for sending a notification of provision of a service. Furthermore, the respective communication apparatuses can exchange follow-up messages for exchanging additional information about a service during the DW period. Note that the publish, subscribe, and follow-up messages will be collectively referred to as service discovery frames (SDFs) hereinafter. The respective communication apparatuses can advertise or detect the service by exchanging the SDFs.

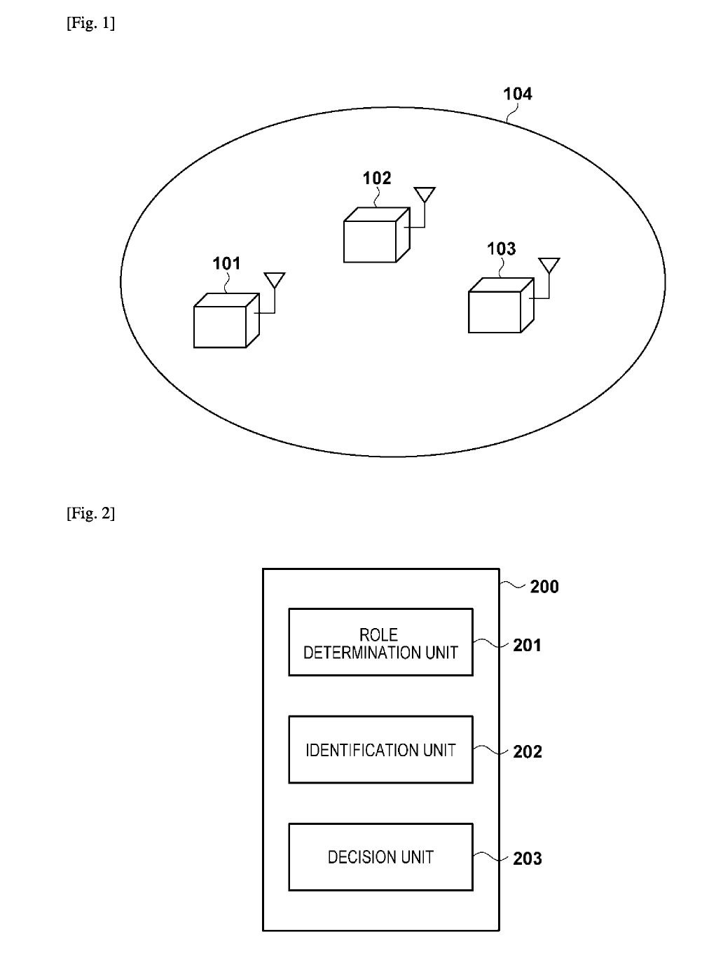

FIG. 1 shows an example of the network configuration of a communication system according to this embodiment. A NAN cluster 104 is formed from terminals 101 to 103. The terminals 101 to 103 are communication apparatuses capable of performing communication complying with the NAN standard. Based on the NAN standard, the terminals 101 to 103 can discover and provide nearby wireless apparatuses and services provided by them. In this embodiment, each of the terminals 101 to 103 joining the NAN cluster 104 performs communication using channel 6 (2.437 GHz) in a frequency band of 2.4 GHz. In this embodiment, in the NAN cluster 104, a DW of 16 TUs (Time Units) is set every 512 TUs. Note that 1 TU corresponds to 1,024 μsec. Each terminal belonging to the NAN cluster 104 communicates service information using the SDFs during each DW period.

In the NAN cluster 104, the terminal 101 operates in the non-master non-sync role. In the NAN cluster 104, the terminal 102 operates in the master role. In the NAN cluster 104, the terminal 103 operates in the non-master sync role. Note that each of the terminals 101 to 103 may operate in another role.

The functional arrangements of the terminals 101 to 103 will be described with reference to FIG. 2. FIG. 2 is a block diagram showing a functional arrangement 200 of the terminal 101 according to this embodiment. Note that the functional arrangements of the terminals 102 and 103 are the same as that of the terminal 101.

A role determination unit 201 determines the role of the terminal 101 in the NAN cluster 104 to which the terminal 101 belongs. The terminal 101 can determine its role based on the master rank and RSSI (Received Signal Strength Indication) of itself. The master rank is a numerical value for deciding the possibility of playing the master role, and is decided based on a master preference (0 to 255) freely set on the terminal side. The RSSI indicates the strength of a signal received by the terminal 101, and is a value representing the reception quality.

An identification unit 202 identifies information about a service for the terminal 101. For example, the identification unit 202 identifies a service name (service_name) as information of a service requested or provided by the terminal 101. Furthermore, the identification unit 202 performs an identification operation for a DW table (FIG. 5) (to be described later) using the identified service name.

Based on the determination result of the role determination unit 201 or the identification result of the identification unit 202, a decision unit 203 decides a DW timing (one of DW0 to DW15) at which the terminal 101 performs communication next.

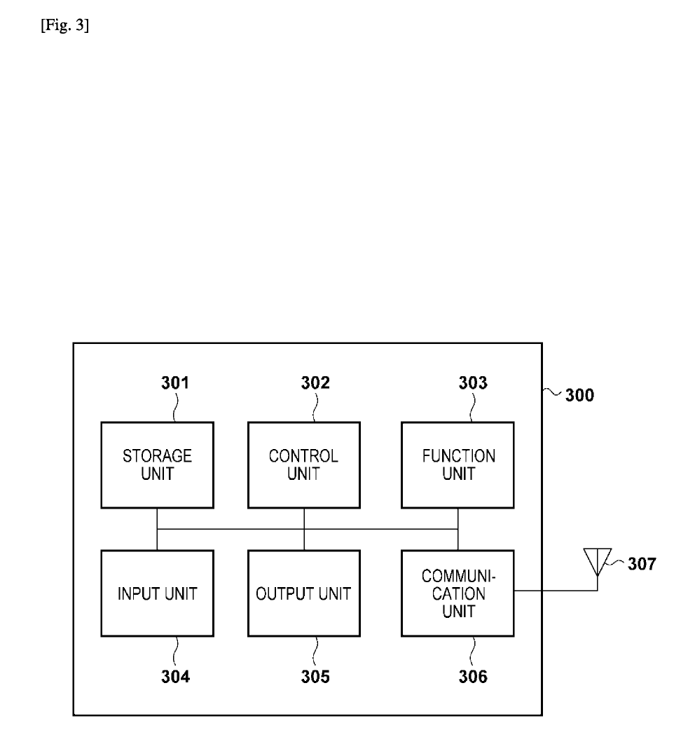

The hardware arrangements of the terminals 101 to 103 will be described with reference to FIG. 3. FIG. 3 is a block diagram showing a hardware arrangement 300 of the terminal 101. Note that the hardware arrangements of the terminals 102 and 103 are the same as that of the terminal 101.

A storage unit 301 is formed by a memory such as a ROM (Read Only Memory) or a RAM (Random Access Memory). The storage unit 301 stores programs for performing various operations (to be described later), and various kinds of information such as communication parameters for wireless communication. Note that instead of the memory such as the ROM or RAM, a storage medium such as a flexible disk, hard disk, optical disk, magnetooptical disk, CD-ROM, CD-R, magnetic tape, nonvolatile memory card, or DVD may be used as the storage unit 301. The storage unit 301 may include a plurality of memories.

A control unit 302 is formed by a processor such as a CPU (Central Processing Unit) or MPU (Micro Processing Unit). The control unit 302 controls the overall terminal 101 by executing the programs stored in the storage unit 301. The control unit 302 may include a plurality of processors such as a multicore processor, which may control the overall terminal 101.

The control unit 302 controls a function unit 303 to execute predetermined processing such as imaging, printing, and projection. The function unit 303 is hardware used by the terminal 101 to execute predetermined processing. If, for example, the terminal 101 is a camera, the function unit 303 serves as an imaging unit and performs imaging processing. If, for example, the terminal 101 is a printer, the function unit 303 serves as a printing unit and performs print processing. If, for example, the terminal 101 is a projector, the function unit 303 serves as a projection unit and performs projection processing. Data processed by the function unit 303 may be data stored in the storage unit 301 or data communicated with another communication apparatus via a communication unit 306 (to be described later).

An input unit 304 accepts various operations from the user. An output unit 305 performs various output operations to the user. The output from the output unit 305 includes at least one of display on a screen, a voice output from a loudspeaker, a vibration output, and the like. Note that both of the input unit 304 and the output unit 305 may be implemented by one module like a touch panel. If the output unit 305 performs an output operation by display, it is formed by, for example, an LCD (Liquid Crystal Display) or LED (Light Emitting Diode). The output unit 305 outputs information which can be visually perceived by the user, and performs display control of various UIs (User Interfaces).

The communication unit 306 is formed by a chip for performing communication complying with the IEEE (Institute of Electrical and Electronic Engineers) 802.11 series. The communication unit 306 controls wireless communication and IP communication. The communication unit 306 controls an antenna 307 to transmit/receive a wireless signal for wireless communication. The terminal 101 communicates a content such as image data, document data, or video data with another communication apparatus via the communication unit 306.

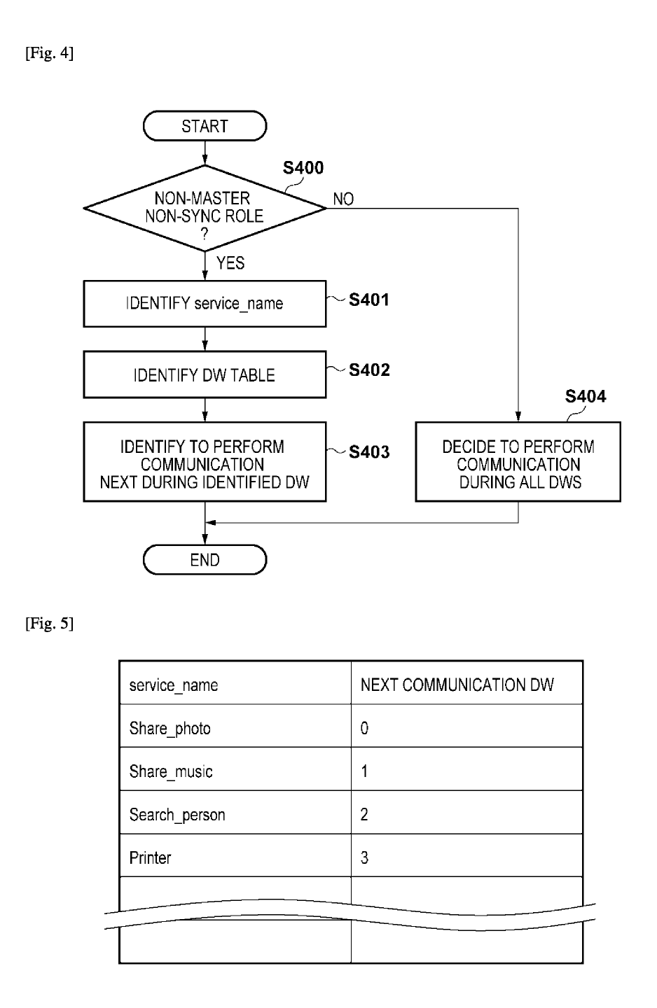

The operations of the terminals 101 to 103 according to this embodiment will be described next. FIG. 4 is a flowchart illustrating the operation of the terminal 101 according to this embodiment. Note that each of the terminals 102 and 103 also executes processing according to the same flowchart as that for the terminal 101.

In this embodiment, after the end of the DW, each of the terminals 101 to 103 decides a DW for performing communication related to a service next, in accordance with the role of itself in the NAN cluster. Note that the flowchart shown in FIG. 4 is implemented when the control unit 302 of the terminal 101 executes a control program stored in the storage unit 301 to execute calculation and processing of information and control of the respective hardware components. Note that some or all of the steps of the flowchart shown in FIG. 4 may be implemented by hardware such as an ASIC.

After the end of a given DW, the role determination unit 201 determines the current role of the terminal 101 in the NAN cluster 104 to which the terminal 101 belongs (step S400). If the role determination unit 201 determines that the role of the terminal 101 is the non-master non-sync role (YES in step S400), the identification unit 202 identifies a service currently requested or provided by the terminal 101 (step S401). In this example, the identification unit 202 identifies a service name service_name as service information. Next, to identify a DW for performing communication next by the terminal 101, the identification unit 202 identifies the DW table using the identified service name service_name (step S402).

FIG. 5 shows an example of the DW table according to this embodiment. In the DW table according to this embodiment, a DW (DW0 to DW15) for performing communication is registered for each service name service_name in association with it. A method of creating a DW table and holding it in each communication apparatus is not limited to a specific one. For example, the communication apparatus joining the NAN cluster may hold a DW table in which DWs are defined in advance with respect to main services. The communication apparatus playing the master role in the NAN cluster may create a DW table, as needed, and notify another communication apparatus in the NAN cluster of it. When the identification unit 202 ends, in step S402, the identification of the DW for performing communication, the decision unit 203 decides, as a DW for performing communication next, the DW identified by the identification unit 202 (step S403). For example, if service_name identified by the identification unit 202 is “share_music” (music sharing service), the decision unit 203 decides DW02 as a DW for performing communication next by the terminal.

On the other hand, if the role determination unit 201 determines in step S400 that the terminal 101 has a role other than the non-master non-sync role (NO in step S400), the decision unit 203 decides that communication related to a service can be performed during all of DW0 to DW15 (step S404). If it is determined that the terminal has a role other than the non-master non-sync role, this means that the terminal operates in the master or non-master sync role. In this case, communication related to a service can be performed during all the DWs.

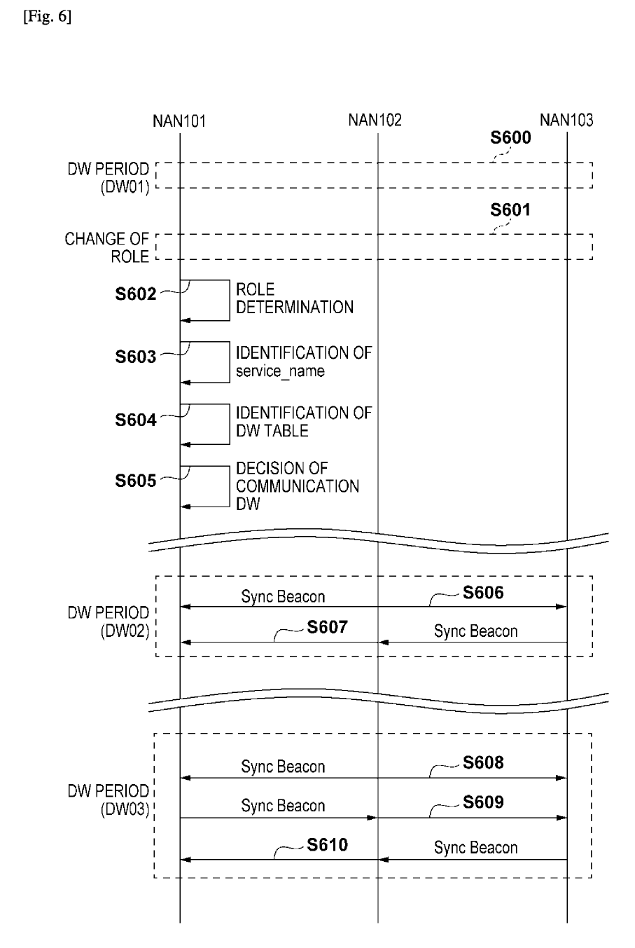

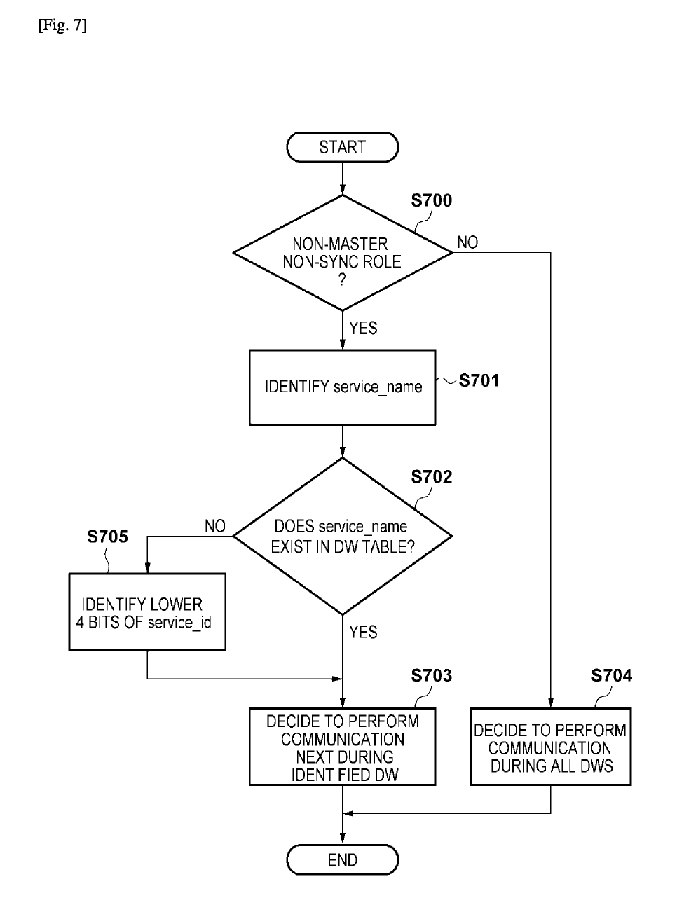

The operations of the terminals 101 to 103 according to this embodiment will be described with reference to FIG. 6. FIG. 6 is a sequence chart showing an example of a processing procedure when each of the terminals 101 to 103 decides, in accordance with its role in the NAN cluster 104, a DW for performing communication next. Assume that the terminal 101 operates in the non-master non-sync role, the terminal 102 operates in the master role, and the terminal 103 operates in the non-master sync role, as shown in FIG. 1.

Referring to FIG. 6, the terminals 101 to 103 perform communication related to the DW period in the NAN cluster 104 using the communication units 306 and the like (S600), and wait, after the end of the DW period, for a period during which the current roles are to be changed (S601). Each role is decided based on the numerical value of the master rank for deciding the master role and the RSSI indicating the value of the communication quality, which are held in each terminal. In this example, the terminal 101 has the non-master non-sync role, the terminal 102 has the master role, and the terminal 103 has the non-master sync role. The role determination unit 201 of the terminal 101 determines its role as the non-master non-sync role (S602). The identification unit 202 of the terminal 101 identifies service_name of the service of itself (S603), and identifies the DW table (S604). After that, in accordance with the DW table, the decision unit 203 of the terminal 101 decides a DW for performing communication related to the service by the terminal 101 next (S605). In this example, the identification unit 202 identifies the service of the terminal 101 as “printer”, and identifies, in accordance with the DW table shown in FIG. 5, DW03 as a DW for performing communication. The decision unit 203 decides DW 03 as a DW for performing communication.

For example, if the next DW after the processing in S605 is performed is DW02, the terminal 102 having the master role operates in the master role to transmit a sync beacon during DW02 (S606). In response to the sync beacon received from the terminal 102, the terminal 103 operates in the non-master sync role to transmit a sync beacon (S607). On the other hand, since DW02 is not a DW for performing communication related to the service by the terminal 101, the terminal 101 does not transmit a sync beacon or perform communication related to the service during DW02. At this time, the terminal 101 sets the communication unit 306 in a power saving state in which no wireless communication is performed. This can reduce the power consumption of the terminal 101.

Similarly to DW02, during DW03 as the next DW, the terminal 102 operates in the master role to transmit the sync beacon (S608). In response to the sync beacon received from the terminal 102, the terminal 103 operates in the non-master sync role to transmit the sync beacon (S609). Furthermore, since DW03 is a DW for performing communication by the service of the terminal 101, the terminal 101 also transmits the sync beacon (S610), and transmits a subscribe message or publish message, as needed. In this case, the DW decided by the decision unit 203 can also be set as the DW for transmitting the subscribe message or publish message.

As described above, in this embodiment, after the end of the DW, the NAN terminal having the non-master non-sync role decides, for each service, a DW for performing communication. This can avoid communication congestion in the NAN cluster, thereby efficiently discovering a service and notifying another apparatus of it.

### Second Embodiment

The first embodiment has described an example in which service names and their corresponding DWs are registered in the DW table. However, the relationship between a service name and its corresponding DW may not be registered in the DW table depending on a service. This embodiment will describe an example in which each of terminals 101 to 103 can decide a DW for performing communication with respect to a service which is not defined in a DW table. Note that this embodiment is applicable in a system which does not use a DW table. A network configuration (FIG. 1), a functional arrangement (FIG. 2), and a hardware arrangement (FIG. 3) are the same as in the first embodiment and a description thereof will be omitted.

FIG. 7 is a flowchart illustrating the operation of the terminal 101 according to this embodiment. The terminal 101 decides a DW for performing communication with respect to a service which is not registered in a DW table. Note that the operations of the terminals 102 and 103 are the same as that of the terminal 101.

Processes in steps S700 and S701 are the same as those in steps S400 and S401 and a description thereof will be omitted. In step S702, an identification unit 202 of the terminal 101 identifies whether identified service_name exists in the DW table. If it is identified that the service of the terminal 101 does not exist in the DW table (NO in step S702), the identification unit 202 identifies the lower 4 bits of service_id as the identifier of the service of the terminal 101 (step S705). service_id is obtained by performing hash processing for service_name. A decision unit 203 assigns, to one of DW0 to DW15, one of numerical values of 0 to 15, which is represented by the lower 4 bits, and decides the assigned DW as a DW for performing communication next (step S703). If YES is determined in step S702, the same processing as in step S403 is performed. If NO is determined in step S700, the same processing as in step S404 is performed (step S704).

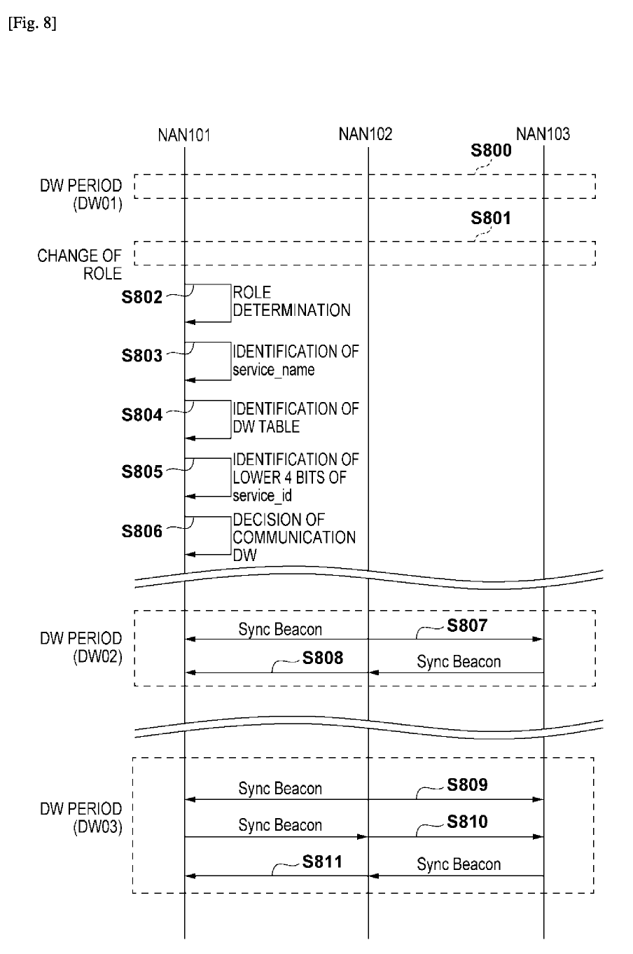

The operations of the terminals 101 to 103 according to this embodiment will be described with reference to FIG. 8. FIG. 8 is a sequence chart showing an example when a DW for performing communication is decided with respect to a service which is not registered in the DW table. Processes in S800 to S803 are the same as those in S600 to S603. If the identification unit 202 of the terminal 101 identifies in S803 that the service of the terminal 101 is not registered in the DW table, the identification unit 202 identifies the lower 4 bits of service_id of itself (S805). Assume that service_name is “chat” and service_id is “83”. In the case of “83”, the lower 4 bits are 0011 which represent “3”, and thus the decision unit 203 of the terminal 101 can decide DW03 as a DW for performing communication by the chat service (S806). Processes in S807 to S811 are the same as those in S606 to S610 and a description thereof will be omitted.

As described above, in this embodiment, if the service of a terminal is not registered in the DW table, a DW is decided based on service_id. This makes it possible to process services which will continue to increase in the future. This can avoid communication congestion, thereby efficiently discovering a service and notifying another apparatus of it.

As described above, according to the above-described embodiments, it is possible to divide a period for communicating service information for each kind of service, avoid congestion of communication of service information, and efficiently search for a service and notify another apparatus of the found service.

Note that in the above-described embodiments, a DW for performing communication related to a service is decided based on a service name or service identifier. However, a DW for performing communication related to a service may be decided based on other information for specifying the service. If a terminal provides or requests a plurality of services, the above-described embodiments are applicable to each service. In this case, the terminal performs communication related to the services during some DWs. If it is determined to perform communication related to a plurality of kinds of services during the same DW, it may be decided that one of the terminals uses an unused DW or the terminals sequentially use the DW of the same number.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-187448, filed Sep. 24, 2015, which is hereby incorporated by reference herein in its entirety.

1. A communication apparatus comprising:
a reception unit configured to receive, during each of cyclically set predetermined periods, a first signal for synchronizing with the predetermined period;
a first determination unit configured to determine a service which can be provided by the communication apparatus;
a decision unit configured to decide, based on the service determined by the first determination unit, a period for transmitting a second signal related to the service among the cyclically set predetermined periods; and
a transmission unit configured to transmit the second signal during the period decided by the decision unit.

2. The apparatus according to claim 1, wherein the predetermined period indicates a discovery window defined in Neighbor Awareness Networking (NAN).

3. The apparatus according to claim 1, wherein one of a data sharing service and a print service is included as the service.

4. The apparatus according to claim 1, wherein the first signal comprises a synchronization beacon defined in Neighbor Awareness Networking (NAN).

5. The apparatus according to claim 1, further comprising:
a second determination unit configured to determine whether the communication apparatus is an apparatus for transmitting the first signal,
wherein if the second determination unit determines that the communication apparatus is not the apparatus for transmitting the first signal, the communication apparatus performs no communication during a period different from the period decided by the decision unit among the cyclically set predetermined periods.

6. The apparatus according to claim 5, wherein if it is determined that the communication apparatus is the apparatus for transmitting the first signal, the communication apparatus performs communication during each of the cyclically set predetermined periods.

7. The apparatus according to claim 5, wherein the second determination unit determines whether the communication apparatus is an apparatus operating in a non-master non-sync role defined in Neighbor Awareness Networking (NAN).

8. The apparatus according to claim 1, wherein the second signal comprises a service discovery frame (SDF) signal defined in Neighbor Awareness Networking (NAN).

9. A control method for a communication apparatus, comprising:
receiving, during each of cyclically set predetermined periods, a first signal for synchronizing with the predetermined period;
determining a service provided by the communication apparatus;
deciding, based on the determined service, a period for transmitting a second signal associated with the service among the cyclically set predetermined periods; and
transmitting the second signal during the decided period.

10. A non-transitory computer-readable storage medium storing a computer program for causing a computer to execute a control method for a communication apparatus, the method comprising:
receiving, during each of cyclically set predetermined periods, a first signal for synchronizing with the predetermined period;
determining a service provided by the communication apparatus;
deciding, based on the determined service, a period for transmitting a second signal associated with the service among the cyclically set predetermined periods; and
transmitting the second signal during the decided period.
